(19) United States
(12) Patent Application Publication
(10) Pub. No.: US 2013/0294498 A1
(43) Pub. Date: Nov. 7, 2013

(54) VIDEO ENCODING SYSTEM, METHOD AND COMPUTER READABLE MEDIUM THEREOF

(71) Applicant: AWIND, INC, New Taipei City (TW)

(72) Inventors: Kuo-Lung CHANG, New Taipei City (TW); Hsing-Yung WANG, New Taipei City (TW); Way LU-CHEN, New Taipei City (TW); Kuan-Yu CHOU, New Taipei City (TW); Meng-Chung HUNG, New Taipei City (TW)

(73) Assignee: Awind, Inc, New Taipei City (TW)

(21) Appl. No.: 13/868,931

(22) Filed: Apr. 23, 2013

(30) Foreign Application Priority Data
May 4, 2012 (TW) 101115966

(51) Int. Cl. H04N 7/26

(52) U.S. Cl. CPC H04N 19/00006
USPC 375/240.02

(57) ABSTRACT

A video encoding system applied in a remote desktop system includes a capturing module, an encoding module and an estimating module. The capturing module is configured for capturing a plurality of screen frames of an electronic device at a capture rate. The encoding module is configured for encoding the screen frames captured by the capturing module at an encoding rate. The estimating module is configured for determining whether the current screen frame changes or not and then adjusting the encoding rate of the encoding module according to the estimating result. In this case, the encoding rate is equal to or less than the capture rate. The video encoding system can reduce system resource usage and energy consumption when the screen frame does not change. A video encoding method and a computer readable medium storing the method are also disclosed.

### BACKGROUND OF THE INVENTION

1. Field of the Invention

The present invention relates to a video encoding system, method and a computer readable medium, and more particularly to a video encoding system, method and a computer readable medium applied to a remote desktop system.

2. Description of the Prior Art

Screen sharing is one important application for information technology, for example, using mote desktop to perform remote control or connecting a computer to a projector for briefing by wireless means. In this technical field, screen frames are obtained by the operation system through software programs and there is no distortion. However, because of bandwidth limitation, screen frames must be encoded to reduce data size for transmission.

Conventionally, transmit end of the remote desktop captures and encodes screen frames at a rate of 24 fps (frame per second) to 30 fps to let remote users have better experience in real-time control. However, more system resources are occupied when the transmit end continually captures and encodes screen frames at the same rate. It also causes more energy consumption.

Hence, it is necessary to develop a method to reduce system resources used by the transmit end of the remote desktop system when encoding and reduces energy consumption.

### SUMMARY OF THE INVENTION

The present invention is directed to a video encoding system, method and a computer readable medium. It determines whether the screen frames change or not and thereby adjusting encoding rate and/or capture rate. As a result, system resources usage and energy consumption are dramatically reduced when no changes occur in screen frames.

According to one embodiment of the present invention, a video encoding system applied to a remote desktop system comprises a capture module, an encoding module, and an estimating module. The capture module is configured for capturing a plurality of screen frames from an electronic device at a capture rate. The encoding module is configured for encoding the screen frames captured by the capture module at an encoding rate. The estimating model is configured for determining whether the current screen frame changes or not and then adjusting the encoding rate of the encoding module according to an estimating result. In this case, the encoding rate is equal to or less than the capture rate.

According to another embodiment of the present invention, a video encoding method applied to a remote desktop system comprises: capturing a plurality of screen frames of an electronic device at a capture rate; encoding the screen frame at an encoding rate; and determining whether the current screen frame changes or not and then adjusting the encoding rate according to an estimating result. In this case, the encoding rate is equal to or less than the capture rate.

According to another embodiment of the present invention, a computer readable medium is configuring for storing a computer program and the computer program is used to be loaded by an electronic device to execute a video encoding method applied to the remote desktop system. The video encoding method comprises: capturing a plurality of screen frames of the electronic device at a capture rate; encoding the screen frame at an encoding rate; and determining whether the current screen frame changes or not and then adjusting the encoding rate according to an estimating result. In this case, the encoding rate is equal to or less than the capture rate.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by ring to the following detailed description, in conjunction with the accompanying drawings, wherein:

FIG. 1 is a block diagram schematically illustrating a video encoding system according one embodiment of the present invention;

FIG. 2 is a block diagram schematically illustrating a video encoding system according another embodiment of the present invention;

FIG. 3 is a flowchart schematically illustrating a video encoding method according one embodiment of the present invention;

FIG. 4 is a block diagram schematically illustrating a video encoding system according another embodiment of the present invention; and

FIG. 5 is a block diagram schematically illustrating a video encoding method according another embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

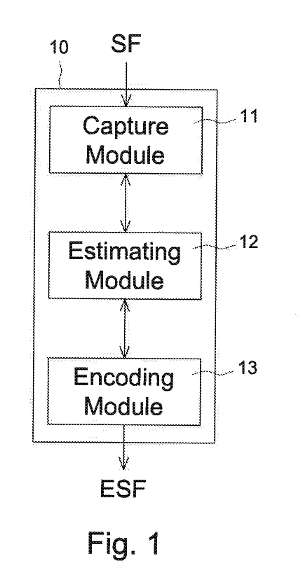

The video encoding system of the present invention is applied to a remote desktop system. Referring to FIG. 1, according to one embodiment of the present invention, a video encoding system 10 comprises a capture module 11, an encoding module 13, and an estimating module 12, The capture module 11 is configured for capturing a plurality of screen frames SF from an electronic device at a capture rate. For example, electronic devices can be desktop computers or mobile in net devices (MID) such as a notebook, a smart phone and a tablet computer. The encoding module 13 is configured for encoding the screen frames SF captured by the capture module 11 at an encoding rate to export an encoded screen frame ESF. The remote desktop system can transmit the encoded screen frames ESF to a remote electronic device to be displayed via internet network or other means of communication.

The estimating model 12 is configured for determining whether the current screen frame SF changes or not and then adjusting the encoding rate of the encoding module 13 according to an estimating result. In one embodiment, the estimating module 12 compares each pixel of the current screen frame SF to the corresponding pixel of the previous screen frame to determine whether the current screen frame changes or not. For example, each pixel of the current screen frame SF can be compared with the corresponding pixel of the previous screen frame by an exclusive OR (XOR) operation to ensure whether the current screen frame changes or not.

In one embodiment of the present invention, when the current screen frame SF does not change, the estimating module 12 decreases the encoding rate of the encoding module 13. For example, initially, the encoding module 13 encodes the screen frame SF at an encoding rate of 24-30 fps. When the estimating module 12 determines that the current screen frame SF does not change, the encoding rate of the encoding module 13 can decrease gradually to 20, 10, 1 or 0 fps. It could be understood that when the estimating module 12 determines the current screen frame SF does not change, the encoding rate of the encoding module 13 can decrease Directly from 24˜30 fps, to 1·0 fps.

In contrast, when the current screen frame SF changes, the estimating module 12 increases the encoding rate of the encoding module 13. For example, when the estimating module 12 determines the current screen frame SF changes, the encoding rate of the encoding module 13 can gradually increase from 0 fps or 1 fps, to 10, 20, 24˜30 fps. It could be understood that in order to let remote users have better experience in real time control, when the estimating module 12 determines the current screen frame changes, the encoding rate of the encoding module 13 can directly increase from 0 or 1 fps, to 24˜30 fps. In one embodiment, the encoding rate can be adjusted between 0 and 100 fps.

It should be noticed that the estimating module 12 also can adjust the capture rate of the capture module 11 according to the estimating result. For example, when the current screen frame SF does not change, the capture rate of the capture module 11 can decrease such like gradually decrease from 24˜30 fps to 20, 10, 1 or 0 fps. When the current screen frame SF changes, the capture rate of the capture module 11 can increase, for example, increase from 1 or 0 fps to 10, 20, 24˜30 fps. In one embodiment, the capture rate can be adjusted between 0 and 100 fps. In one embodiment, the encoding rate is equal to or less than the capture rate.

Based on the description above, the video encoding system 10 of the present invention can adjust encoding rate and/or capture rate depending on whether the current screen frame changes. Accordingly, system resources usage and energy consumption can be reduced.

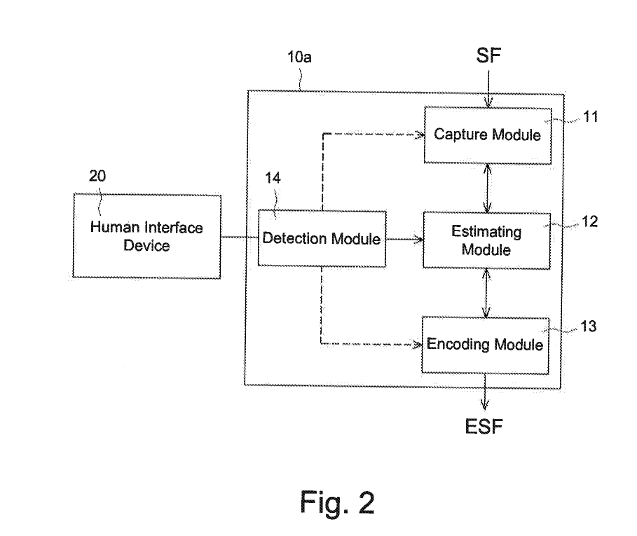

Referring to FIG. 2, according to another embodiment of the present invention, a video encoding system 10a further comprises a detection module 14 to detect an input signal of a human interface device (Human Interface Device, HID) 20 such like a keyboard, a mouse and other input devices to determine whether the electronic device is operated normally. When the electronic device is operated, the detection module 14 can provides proper control signals to increase the capture rate of the capture module 11 and/or the encoding rate of the encoding module 13. For example, the detection module 14 can adjust the capture rate or/and the encoding rate via the estimating module 12, but not limited to this. The detection module 14 also can directly adjust the capture rate of the capture module 11 and/or the encoding rate of the encoding module 13, referring to the dashes as shown in FIG. 2. Based on the description above, when the capture rate decreases to 0 fps, the capture module 11 can be restored to capture the screen frame SF according to the detection result of the detection module 14.

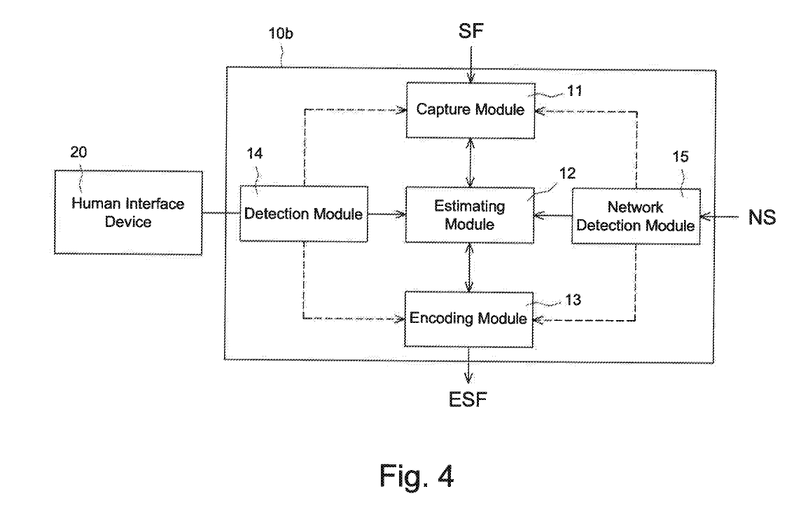

Referring to FIG. 4, the video encoding system 10b further comprises a network detection module 15 configured for detecting network status NS to determine whether the network is congested. When the network is congested, the network detection module 15 provides proper control signals to decrease the capture rate of the capture module 11 and/or the encoding rate of the encoding module 13. Similarly, the network detection module 15 can adjust the capture rate and/or the encoding rate via the estimating module 12, as shown by solid lines in FIG. 4; or the network detection module 15 can directly adjust the capture rate and/or the encoding rate, as shown by dashed lines in FIG. 4. For example, when the network is in the normal condition, the capture rate and/or the encoding rate should be increased if the screen frame changes. However, when the network is congested, the encoded screen frame ESF cannot be transmitted to the receiving end. To solve this problem, the capture rate and/or the encoding rate can be decreased to reduce system resource usage and energy consumption.

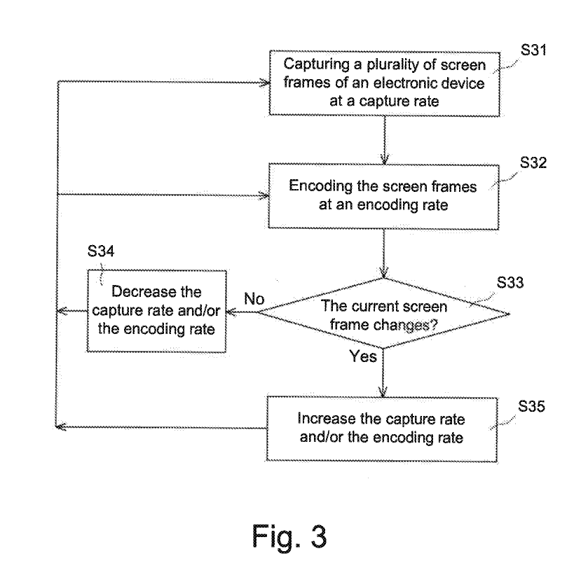

A video encoding method applied to a remote desktop system is also disclosed here. Referring to FIG. 3, according to an embodiment of the present invention, a video encoding method applied to a remote desktop system comprises: capturing a plurality of screen frames of an electronic device at a capture rate (S31); encoding the screen frame at an encoding rate (S32); and determining whether the current en frame changes or not and then adjusting the capture rate and/or the encoding rate according to an estimating result (S33). For instance, when the current screen frame does not change, decrease the capture rate and/or the encoding rate (S34) and reset the capture rate in the step S31 and/or the encoding rate in the step 32. In contrast, when the current screen frame changes, increase the capture rate and/or the encoding rate (S35) and reset the capture rate in the step S31 and/or the encoding rate in the step S32. Technical details are described before and will not be elaborated here.

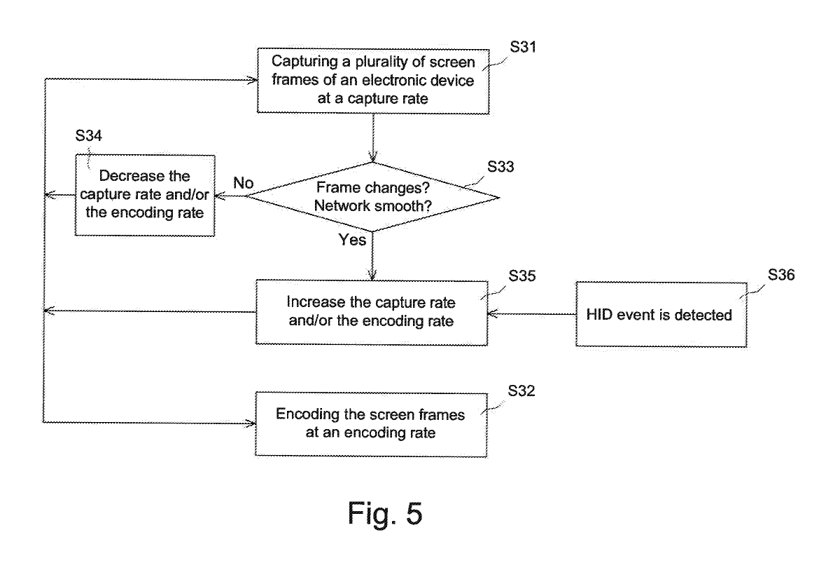

In one embodiment, referring to FIG. 5, a video encoding method further comprises detecting an input signal of a human interface device (HID) to determine whether the electronic device is operated; if an HID event is detected (S36), the capture rate and/or the encoding rate are increased. Besides, the step S33 further determines whether the network is congested so as to correspondingly adjust the capture rate and/or the encoding rate. Technical details are described before and will not be elaborated hereinafter. It should be noticed that after the step S31 of capturing the screen frame according to the embodiment shown in FIG. 5, the step S33 immediately determines whether the screen frame changes so as to correspondingly adjust the encoding rate. For example, when the capture rate increases, the encoding module decreases the encoding rate in response. In contrast, when the capture rate increases, the encoding rate increases in response. In other words, the encoding rate can be correspondingly adjusted by adjusting the capture rate.

A computer readable medium is also disclosed here. According to an embodiment of the present invention, a computer readable medium is configured for storing a computer program and the computer program is used to be loaded by an electronic device to execute a video encoding method as shown in FIG. 3 or FIG. 5. The video encoding method of the present invention is described in detail before and will not be elaborated here.

In conclusion, the video encoding system and method of the present invention can adjust encoding rate and/or capture rate depending on whether the current screen frame changes or not. Accordingly, system resources usage and energy consumption can be reduced dramatically when the screen frame does not change. Besides, the video encoding system and method of the present invention also can detect HID event or network status to dynamically adjust the encoding rate and/or capture rate.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A video encoding system applied to a remote desktop system, comprising:
a capture module configured for capturing a plurality of screen frames of an electronic device at a capture rate;
an encoding module configured for encoding the screen frames captured by the capture module at an encoding rate; and
an estimating model configured for determining whether the current screen frame changes or not and then adjusting the encoding rate of the encoding module according to an estimating result, wherein the encoding rate is equal to or less than the capture rate.

2. The video encoding system according to claim 1, wherein the encoding rate is decreased when the current screen frame does not change or the encoding rate is increased when the current screen frame changes.

3. The video encoding system according to claim 1, wherein the estimating module adjusts the capture rate of the capture module according to the estimating result.

4. The video encoding system according to claim 3, wherein the capture rate is decreased when the current screen frame does not change or the capture rate is increased when the current screen frame changes.

5. The video encoding system according to claim 1, wherein the estimating module compares each pixel of the current screen frame to the corresponding pixel of the previous screen frame to determine whether the current screen frame changes.

6. The video encoding system according to claim 1 further comprising a detection module to detect an input signal of a human interface device to determine whether the electronic device is operated; if yes, the capture rate or the encoding rate is increased.

7. The video encoding system according to claim 1 further comprises:
a network detection module used for detecting a network status to determine whether the network is congested and correspondingly adjusts the encoding rate and/or the capture rate.

8. The video encoding system according to claim 1, wherein the capture rate is between 0 and 100 frames per second.

9. The video encoding system according to claim 1, wherein the encoding rate is between 0 and 100 frames per second.

10. A video encoding method applied to a remote desktop system comprising:
capturing a plurality of screen frames of an electronic device at a capture rate;
encoding the screen frames at an encoding rate; and
determining whether the current en frame changes or not and then adjusting the encoding rate according to an estimating result, wherein the encoding rate is equal to or less than the capture rate.

11. The video encoding method according to claim 10, wherein the encoding rate is decreased when the current screen frame does not change or the encoding rate is increased when the current screen frame changes.

12. The video encoding method according to claim 10, wherein the determining step further comprises adjusting the capture rate according to the estimating result.

13. The video encoding method according to claim 12, wherein the capture rate is decreased when the current screen frame does not change or the capture rate is increased when the current screen frame changes.

14. The video encoding method according to claim 10, wherein determining whether the current screen frame changes or not is accomplished by comparing each pixel of the current screen frame to the corresponding pixel of the previous screen frame.

15. The video encoding method according to claim 10 further comprising:
detecting an input signal of a human interface device to determine whether the electronic device is operated; if yes, the capture rate or the encoding rate is increased.

16. The video encoding system according to claim 10 further comprises:
detecting a network status to determine whether the network is congested and correspondingly adjusts the encoding rate and/or the capture rate.

17. The video encoding method according to claim 10, wherein the capture rate is between 0 and 100 frames per second.

18. The video encoding method according to claim 10, wherein the encoding rate is between 0 and 100 frames per second.

19. A computer readable medium storing a computer program, the computer program is used to be loaded by an electronic device to execute a video encoding method applied to the remote desktop system, wherein the method comprises:
capturing a plurality of screen frames of the electronic device at a capture rate;
encoding the screen frame at an encoding rate; and
determining whether the current screen frame changes or not and then adjusting the encoding rate according o an estimating result, wherein the encoding rate is equal to or less than the capture rate.

20. The computer readable medium according to claim 19, wherein the encoding rate is decreased when the current screen frame does not change or the encoding rate is increased when the current screen frame changes.

21. The computer readable medium according to claim 19, wherein the determining step further comprises adjusting the capture rate according to the estimating result.

22. The computer readable medium according to claim 21, wherein the capture rate is decreased when the current screen frame does not change or the capture rate is increased when the current screen frame changes.

23. The computer readable medium according to claim 19, wherein determining whether the current screen frame changes or not is accomplished by comparing each pixel of the current screen frame to the corresponding pixel of the previous screen frame.

24. The computer readable medium according to claim 19, wherein the method further comprises:
detecting an input signal of a human interface device to determine whether the electronic device is operated; if yes, the capture rate or the encoding rate is increased.

25. The video encoding system according to claim 19 further comprises:
detecting a network status to determine whether the network is congested and correspondingly adjusts the encoding rate and/or the capture rate,

26. The computer readable medium according to claim 19, wherein the capture rate is between 0 and 100 frames per second.

27. The computer readable medium according to claim 19, wherein the encoding rate is between 0 and 100 frames per second.
